(19) United States
(12) Patent Application Publication
(10) Pub. No.: US 2015/0316675 A1
(43) Pub. Date: Nov. 5, 2015

(54) OFFSHORE SEISMIC MONITORING SYSTEM AND METHOD

(71) Applicant: CGG Services SA, Massy (FR)

(72) Inventors: Thierry Brizard, Massy (FR); Salvador Rodriguez, Massy (FR)

(73) Assignee: CGG Services SA, Massy (FR)

(21) Appl. No.: 14/648,496

(22) PCT Filed: Dec. 10, 2013
(86) PCT No.: PCT/EP2013/076102

§ 371 Date: May 29, 2015

Related U.S. Application Data
(60) Provisional application No. 61/791,672, filed on Mar. 15, 2013.
(60) Provisional application No. 61/735,259, filed on Dec. 10, 2012.

(51) Int. Cl. G01V 1/38; G01V 1/18

(52) U.S. Cl. CPC G01V 1/3852; G01V 1/18; G01V 1/3808

(57) ABSTRACT

System and method for monitoring a reservoir underwater. The system includes plural nodes, each having a seismic sensor for detecting seismic waves; a remote operated vehicle (ROV) configured to deploy or retrieve the plural nodes to seabed; and an autonomous underwater vehicle (AUV) configured to monitor and exchange data with the plural nodes. At least one node of the plural nodes has a head that houses the seismic sensor and the head is configured to burrow in the seabed, up to a predetermined depth, and the head remains in electrical contact through a connector with a base of the at least one node.

### BACKGROUND

1. Technical Field

Embodiments of the subject matter disclosed herein generally relate to methods and systems and, more particularly, to mechanisms and techniques for performing offshore marine seismic monitoring using a combination of at least one autonomous underwater vehicle (AUV), at least one remotely operated vehicle (ROV) and seismic nodes with self-burrowing seismic sensors.

2. Discussion of the Background

Marine seismic data acquisition and processing generate a profile (image) of a geophysical structure under the seafloor. While this profile does not provide an accurate location of oil and gas reservoirs, it suggests, to those trained in the field, the presence or absence of these reservoirs. Thus, providing a high-resolution image of the geophysical structures under the seafloor is an ongoing process.

Reflection seismology is a method of geophysical exploration to determine the properties of earth's subsurface, which are especially helpful in the oil and gas industry. Marine reflection seismology is based on using a controlled source of energy that sends acoustic energy into the earth. By measuring the time it takes for the reflections to come back to plural receivers, it is possible to evaluate the depth of features causing such reflections. These features may be associated with subterranean hydrocarbon deposits.

When used on water, this method may employ one or more vessels that tow streamers and seismic sources. The seismic sources are shot at predetermined times to generate seismic waves. The seismic waves propagate downward toward the seafloor and penetrate the seafloor until eventually a reflecting structure reflects the seismic waves. The reflected seismic waves then propagate upward until they are detected by various seismic receivers distributed on the streamers. Based on the data collected by the receivers, an image of the subsurface is generated by further analysis. Thus, an oil and/or gas reservoir may be discovered.

However, after the oil and/or gas reservoir has been discovered, it needs to be monitored to observe how the amount of oil and/or gas changes over time. For this goal, another method may be used to monitor the reservoir as illustrated in FIG. 1. Suppose that a reservoir 102 is buried under the seabed 104. A seismic monitoring system 100 may include ocean bottom nodes (OBNs, i.e., seismic sensors) 106 distributed across seabed 104 for monitoring reservoir 102 and connected to each other with cables for transmitting recorded seismic data to a controller 108. A seismic source 110, e.g., towed by a vessel or located on an AUV, may generate the seismic waves while the OBNs 106 record the produced seismic data. Another AUV may travel to controller 108 and collect the recorded seismic data.

This traditional way of monitoring a reservoir has its own limitations. For example, the coupling between OBNs 106 and seabed 104 is not good, which results in high noise being recorded and, thus, a poor signal. Another disadvantage of the traditional method is the complicated nature of having OBNs connected to each other by cables and also to a global controller.

Accordingly, it would be desirable to provide systems and methods for recording seismic waves that provide good coupling with the seabed as well as easy deployment and maintenance.

### SUMMARY

According to an embodiment, there is a system for monitoring a reservoir underwater. The system includes plural nodes, each having a seismic sensor for detecting seismic waves; a remote operated vehicle (ROV) configured to deploy or retrieve the plural nodes to seabed; and an autonomous underwater vehicle (AUV) configured to monitor and exchange data with the plural nodes. At least one node of the plural nodes has a head that houses the seismic sensor and the head is configured to burrow in the seabed, up to a predetermined depth, and the head remains in electrical contact through a connector with a base of the at least one node and the head houses the seismic sensor.

According to another embodiment, there is a method for monitoring a reservoir underwater. The method includes a step of using a remote operated vehicle (ROV) to deploy or retrieve plural nodes to seabed; a step of deploying an autonomous underwater vehicle (AUV) to monitor and exchange data with the plural nodes; a step of generating seismic waves with a seismic source; a step of recording with the plural nodes the seismic waves; and a step of transferring data indicative of the seismic waves to a processing facility for generating a final image of the reservoir. At least one node of the plural nodes has a head that houses the seismic sensor and the head is configured to burrow in the seabed, up to a predetermined depth, and the head remains in electrical contact through a connector with a base of the at least one node during the seismic survey.

According to another exemplary embodiment, there is a system for monitoring a reservoir underwater. The system includes plural nodes, each having a seismic sensor for detecting seismic waves; a remote operated vehicle (ROV) configured to deploy or retrieve the plural nodes to seabed; an autonomous underwater vehicle (AUV) configured to monitor and exchange data with the plural nodes; a vessel configured to provide support for the AUV and the ROV; and a cage that is deployed from the vessel to the seabed and configured to store part of the plural nodes. At least one node of the plural nodes has a head that houses the seismic sensor and the head is configured to burrow in the seabed, up to a predetermined depth.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional seismic monitoring system;

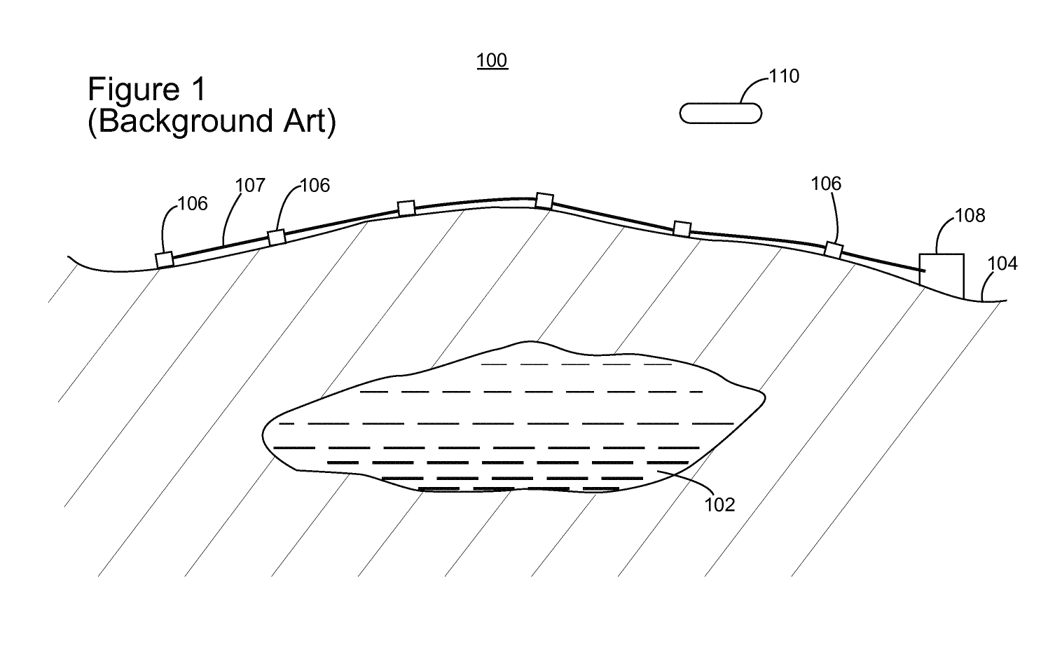

FIG. 2 is a schematic diagram of a seismic monitoring system having nodes with self-burying heads according to an embodiment;

FIG. 3 is a schematic diagram of a node having a self-burying head according to an exemplary embodiment;

FIG. 4 is a schematic diagram of an AUV;

FIG. 5 is another schematic diagram of an AUV;

FIG. 6 is a schematic diagram of an ROV according to an embodiment;

FIG. 7 is a schematic diagram of a cage according to an embodiment;

FIG. 8 is a schematic diagram of a system for monitoring a reservoir according to an embodiment;

FIG. 9 is a schematic diagram of another system for monitoring a reservoir according to an embodiment;

FIG. 10 is a flowchart of a method for monitoring a reservoir with a seismic system according to an embodiment;

FIG. 11 is a flowchart of a method for deploying a node with a self-burying head according to an embodiment; and

FIG. 12 is a schematic diagram of a controller.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of seismic nodes that are deployed by ROVs, exchange seismic data with AUVs and have seismic sensors that burrow into the seabed. However, the embodiments to be discussed next are not limited to this combination of devices, but, may be applied to other devices, e.g., gliders, vessels, cages, etc.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Emerging technologies in marine seismic surveys need an inexpensive system for deploying and retrieving seismic receivers from the seabed. According to an exemplary embodiment, such a seismic system includes plural nodes having seismic receivers that can burrow into the seabed after they have landed there. The nodes may be deployed/retrieved by ROVs. ROVs may also provide other functions, e.g., recharge/replace the nodes' batteries. The seismic sensors may be one of a hydrophone, geophone, accelerometers, electromagnetic sensors, or a combination of them. The AUV may be used to harvest the seismic data and/or quality data from the nodes. Further, the AUV may also be used to determine faulty nodes, recharge the nodes' batteries, control the operational mode, etc.

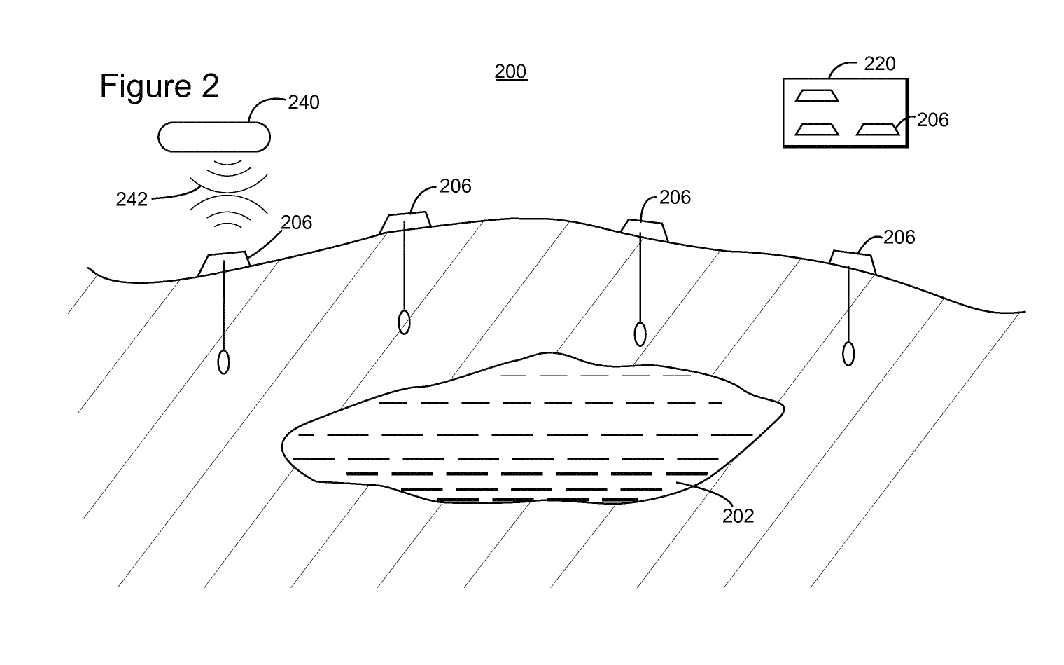

According to an embodiment illustrated in FIG. 2, a seismic monitoring system 200 includes plural nodes 206 that are distributed on the seabed 204 to monitor a reservoir 202. As illustrated in this figure, system 200 also includes at least one ROV 220 configured to deploy/recover nodes 206 while an AUV 240 communicates with the nodes for harvesting the data (both seismic and non-seismic). For example, both AUV 240 and nodes 206 may employ a wireless interface for exchanging electromagnetic signals 242 between the two. The structure of each element of the system is now discussed in more detail, after which the operation of the entire system is explained.

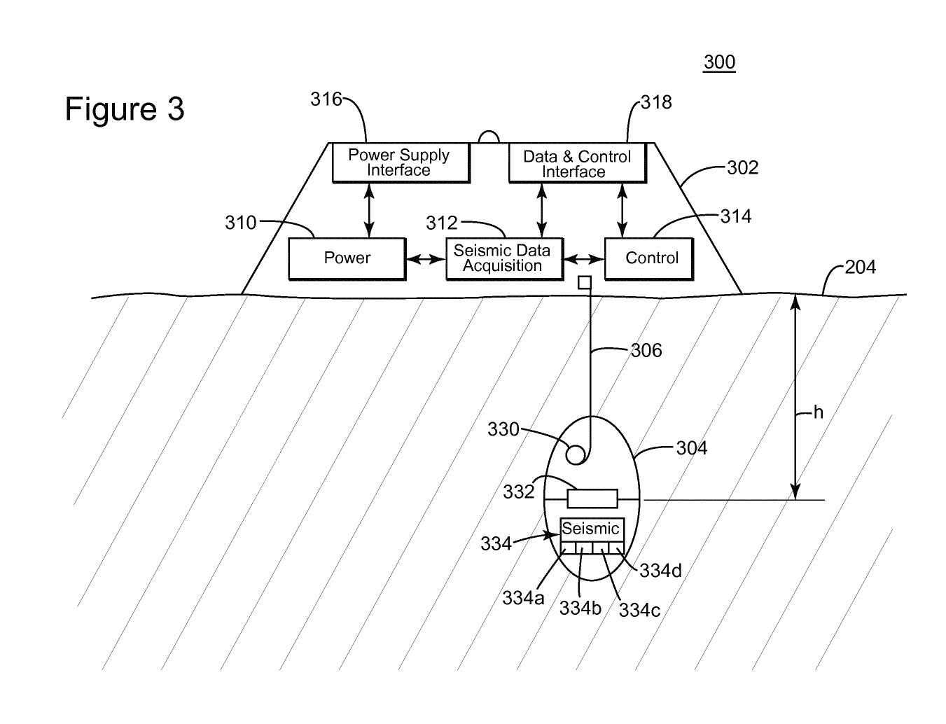

A node 300 (which corresponds to node 206 in FIG. 2) is illustrated in FIG. 3 and has a base portion 302 that, after deployment, is sitting on seabed 204 and also has a self-burying head 304 attached to the base 302 by a connector 306. Connector 306 may include at least one of a strength element, power cord, data communication wire, etc. In one application, self-burying head 304 can be fully retracted within base 302. However, in another application, part of head 304 may extend from base 302, although the head is stored inside the base. Base 302 may include a power supply unit 310, e.g., a battery, a fuel cell or other power sources, a seismic data acquisition unit 312 and a controller 314. These units are connected to each other. The seismic data acquisition unit 312 may include a processor and memory for storing seismic data recorded by the seismic sensor located in head 304. The processor and other electronics may be used to, for example, perform basic processing on the collected seismic data. Also, seismic data acquisition unit 312 may interact with the AUV and/or ROV through a data and control interface 318 to exchange various data. For example, the ROV and/or AUV may communicate with seismic data and acquisition unit 312 or controller 314 to transmit a start time for recording seismic data, a duration time for how long and how often to record seismic data, etc. Also, interface 318 may be used to send the recorded seismic data to the AUV and/or ROV, or to send quality control data, or to send status information, e.g., battery status or sensor status.

Base 302 also may include a power supply interface 316 for exchanging power with the ROV and/or AUV. In one application, when a low-battery status is detected by the AUV, either the AUV or the ROV may connect with a dedicated interface to interface 316 for recharging the node's power supply unit 310. In one application, either the AUV or the ROV may in fact replace power supply unit 310 with a new power supply unit.

Controller 314 also communicates with head 304. After base 302 has landed on seabed 204, controller 314 may instruct head 304 to burrow into the seabed. FIG. 3 illustrates head 304 buried to a depth h from seabed 204. Controller 314 may also instruct head 304 to stop burying itself when the desired depth h has been reached. In one embodiment, the desired depth h is about 20 m. Other values may be used, depending on the target of the survey, the consistency of the seabed, etc.

Still with regard to FIG. 3, head 304 may include a reel 330 on which connector 306 may be wound so that the distance between the head and the base is adjusted accordingly. The reel may be controlled by controller 314. Energy for actuating the reel may be provided by power supply unit 310. Head 304 may also include an actuator 332 for advancing the entire head toward the desired depth. An example of an actuator that buries the head in the seabed is disclosed in U.S. Patent Application Publication No. 2010/0300752, the entire content of which is incorporated herein by reference. Such an actuator may include a tank of a pressurized fluid, which is used to move one or more pistons to bury the head. Alternatively, the actuator may include an electrical motor for burying the head. However, other types of actuators may be used instead of the one described in this patent application.

Head 304 may also have a seismic unit 334 which may include one or more seismic sensors 334a, a storage device 334b for storing the recorded seismic data, a processor 334c for processing the seismic data, and/or electronics for performing standard procedures, e.g., digitizing the data, etc. In one application, seismic unit 334 may also include a seismic source 334d for generating seismic waves. These seismic waves propagate toward the reservoir 202, and their reflections are recorded by seismic sensors 334a.

Returning to FIG. 2, AUV 240 may be a specially-designed device or an off-the-shelf device so that it is inexpensive. A deployment vessel may store the AUVs and launch them as necessary for the seismic survey. The AUVs find their desired positions (preprogrammed in their local control device) using, for example, an inertial navigation system. The desired positions correspond to the positions of the nodes. After the AUV interacts with the nodes, it returns to a recovery vessel or the deployment vessel. In another application, the AUV may dock with a base station located on the seabed.

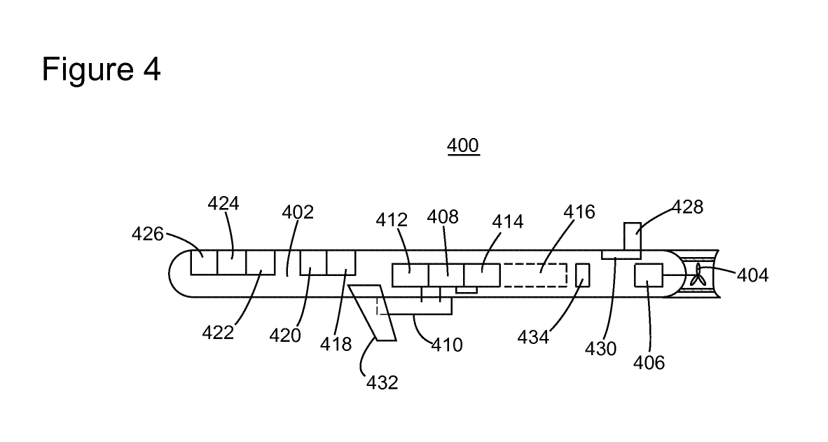

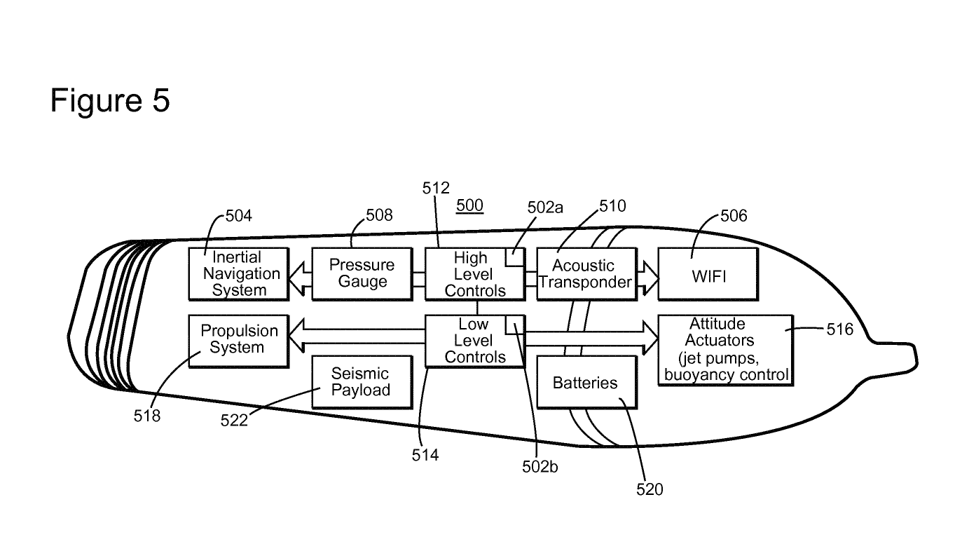

A structure of an AUV is now discussed in more detail with regard to FIGS. 4-5. FIG. 4 illustrates an AUV 400 having a body 402 to which one or more propellers 404 are attached. A motor 406 inside body 402 activates propeller 404. Motor 406 may be controlled by a processor 408, which may also be connected to a seismic sensor 410. Seismic sensor 410 may be shaped so that when the AUV lands on the seabed, the seismic sensor achieves a good coupling with seabed sediments. The seismic sensor may include one or more of a hydrophone, geophone, accelerometer, etc. For example, if a 4C (four component) survey is desired, seismic sensor 410 includes three accelerometers and a hydrophone, i.e., a total of four sensors. Alternatively, the seismic sensor may include three geophones and a hydrophone. Of course, other sensor combinations are possible.

A memory unit 412 may be connected to processor 408 and/or seismic sensor 410 for storing seismic sensor's 410 recorded data. A battery 414 may be used to power all these components. Battery 414 may be allowed to change its position along a track 416 to alter the AUV's center of gravity.

The AUV may also include an inertial navigation system (INS) 418 configured to guide the AUV to a desired location. An inertial navigation system includes at least a module containing accelerometers, gyroscopes, magnetometers or other motion-sensing devices. The INS is initially provided with the position and velocity of the AUV from another source, for example, a human operator, a GPS satellite receiver, another INS from the vessel, etc., and thereafter, the INS computes its own updated position and velocity by integrating (and optionally filtrating) information received from its motion sensors. The advantage of an INS is that it requires no external references in order to determine its position, orientation or velocity once it has been initialized.

Besides or instead of INS 418, AUV 400 may include a compass 420 and other sensors 422 such as, for example, an altimeter for measuring its altitude, a pressure gauge, an interrogator module, etc. The AUV may optionally include an obstacle avoidance system 424 and a communication device 426 (e.g., Wi-Fi device, a device that uses an acoustic link) or other data transfer device capable of wirelessly transferring data. One or more of these elements may be linked to processor 408. The AUV further includes an antenna 428 (which may be flush with the AUV's body) and a corresponding acoustic system 430 for communicating with the deploying, shooting or recovery vessel. Stabilizing fins and/or wings 432 for guiding the AUV to the desired position may be used together with the propeller 404 for steering the AUV. However, as disclosed in later embodiments, such fins may be omitted. The AUV may include a buoyancy system 434 for controlling the AUV's depth and keeping it steady after landing.

Acoustic system 430 may be an Ultra-short baseline (USBL) system, also sometimes known as a Super Short Base Line (SSBL). This system uses a method of underwater acoustic positioning. A complete USBL system includes a transceiver, which is mounted on a pole under a vessel, and a transponder/responder on the AUV. A processor is used to calculate a position from the ranges and bearings measured by the transceiver. For example, the transceiver transmits an acoustic pulse that is detected by the subsea transponder, which replies with its own acoustic pulse. This return pulse is detected by the transceiver on the vessel. The time from the initial acoustic pulse transmission until the reply is detected is measured by the USBL system and converted into a range. To calculate a subsea position, the USBL calculates both a range and an angle from the transceiver to the subsea AUV. Angles are measured by the transceiver, which contains an array of transducers. The transceiver head normally contains three or more transducers separated by a baseline of, e.g., 10 cm or less.

With regard to the AUV's internal configuration, FIG. 5 schematically shows a possible arrangement for the internal components of an AUV 500. AUV 500 has a CPU 502a connected to INS 504 (or compass or altitude sensor and acoustic transmitter for receiving acoustic guidance from the mother vessel), wireless interface 506, pressure gauge 508, and transponder 510. CPU 502a may be located in a high-level control block 512. The INS is advantageous when the AUV's trajectory has been changed, for example, because of an encounter with an unexpected object, e.g., fish, debris, etc., because the INS is capable of taking the AUV to the desired final position as it does for currents, wave motion, etc. Also, the INS may have high precision. For example, it is expected that for a target having a depth of 300 m, the INS and/or the acoustic guidance is capable of steering the AUV within +/−5 m of the desired target location. However, the INS may be configured to receive data from the vessel to increase its accuracy. An optional CPU 502b, in addition to CPU 502a, is part of a low-level control module 514 configured to control attitude actuators 516 and propulsion system 518. The high-level control block 512 may communicate via a link with the low-level control module 514 as shown in the figure. One or more batteries 520 may be located in AUV 500. A seismic payload 522 is located inside the AUV for recording the seismic signals. Those skilled in the art would appreciate that more modules may be added to the AUV. For example, if a seismic sensor is outside the AUV's body, a skirt may be provided around or next to the sensor. A water pump may pump water from the skirt to create a suction effect so that a good coupling between the sensor and the seabed is achieved. However, there are embodiments where no coupling with the seabed is desired. For those embodiments, no skirt is used. In an exemplary embodiment, the seismic survey is performed with the seismic sensors of the AUVs and with sensors provided on nodes 206.

Once retrieved on the vessel, the AUVs are checked for problems, their batteries may be recharged or replaced, and the stored seismic data may be transferred on the vessel for processing. After this maintenance phase, the AUVs are again deployed as the seismic survey continues. Thus, in one exemplary embodiment, the AUVs are continuously deployed and retrieved. In still another exemplary embodiment, the AUVs are configured to not transmit the seismic data to the deployment or shooting or recovery vessel while the AUVs are underwater.

In another embodiment, each node 300 may be replaced with AUV 500. In other words, instead of deploying passive nodes 300 to the seabed, AUVs having similar configurations with the AUVs 400 and 500 may be used to carry heads 304. Once the AUVs are deployed on the seabed, the heads may be instructed to burrow and then the seismic sensors from the heads record the seismic data. For this embodiment, either the ROV and/or cage to be discussed next may be used or the AUVs may be directly launched from a support vessel and then recovered by the same or a different vessel when the seismic survey is over.

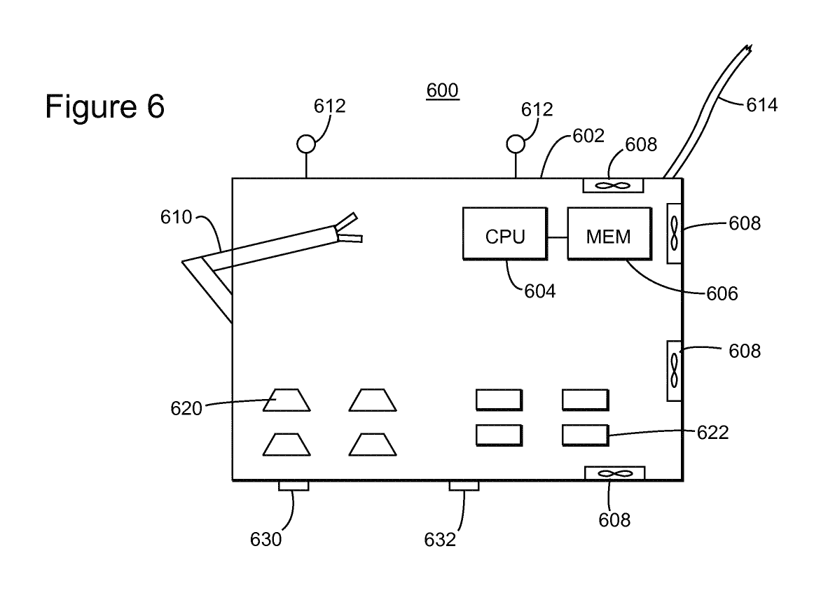

Next, a structure of the ROV is discussed with regard to FIG. 6. ROV 600 may have a frame 602 to which a processor 604 and a storage device 606 are attached. Plural actuators, e.g., propellers 608, are coordinated by processor 604 for guiding the ROV underwater. ROV 600 may include a robotic arm 610 for deploying/retrieving nodes 206. One or more cameras 612 may be attached to frame 602 for monitoring the positions of the ROV and its robotic arm. The ROV may be controlled by an operator from the surface through a tether 614. The operator may use cameras 612 for driving the ROV and for maneuvering nodes and other equipment. Plural slots 620 may be formed in frame 602 for accommodating nodes 206. Alternately, the ROV may have a basket that stores nodes 206. Further, slots 622 may be formed in frame 602 for accommodating power units 310. Thus, in one application, an ROV may be deployed to remove a depleted power unit 310 from a node 206 and replace it with a charged power unit 310 stored on the ROV. The entire changing operation may be monitored from the surface via cameras 612, and the exchange is achieved by using robotic arm 610. In another application, a power interface 630 is used to contact power interface 316 of node 300 to transfer power from the ROV to nodes. A data and control interface 632 may be used for transferring seismic data from node 206 to storage device 606, or for transferring operational instructions to controller 314 of node 300.

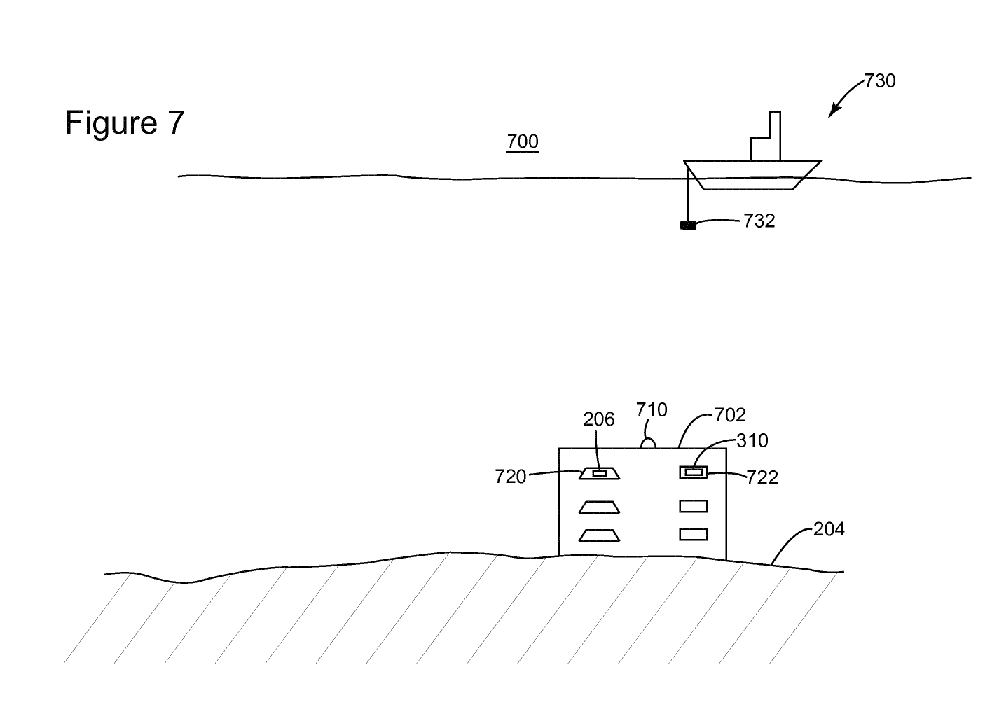

In another embodiment illustrated in FIG. 7, a cage 700 may be deployed on seabed 204, and cage 700 may have multiple node slots 720 for storing nodes 206 and/or multiple power slots 722 for storing power supply units 310. Cage 700 has a housing 702 which accommodates the node and power slots. The housing may be dimensioned to fit tens, if not hundreds, of nodes. Housing 702 may also include a connecting mechanism 710 for connecting to a hook or other connecting device 732 extending from a supporting vessel 730 floating at the water surface. Thus, cage 700 may be retrieved to the vessel, filled with nodes and charged power supply units, and then deployed on the seabed.

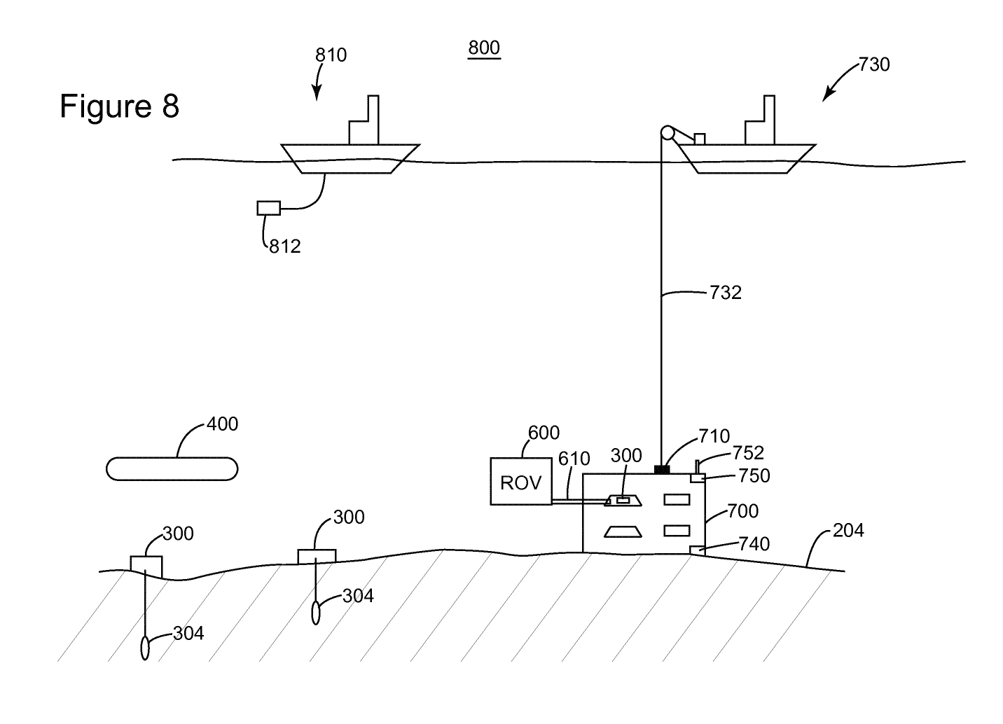

The operational aspects of deploying, using and retrieving nodes 300, are now discussed. In an embodiment illustrated in FIG. 8, vessel 730 has deployed cage 700 on seabed 204. Cage 700 stores plural nodes 300 and/or power supply units 310. Nodes 300 have been checked previously on board vessel 730 to ensure they have a fully-charged power supply unit, the seismic sensor(s) are working and all the other components are operating normally. ROV 600 may be deployed by the same vessel 730 or a dedicated support vessel. ROV 600 is then guided to approach cage 700 and remove, one by one, nodes 300 for deploying them on seabed 204. In one application, cage 700 may still hang from connecting mechanism 732 while the ROV removes the nodes, i.e., cage 700 may not touch the seabed. However, for stability reasons, it is preferable to have cage 700 parked on the seabed. Although FIG. 8 shows the vessel's connecting device 732 still attached to the cage's connecting mechanism 710, this may not be the case after the cage is deployed on the seabed.

ROV may deploy nodes 300 along a predetermined pattern, i.e., a regular grid. In one application, while ROV 600 deploys one node, the previously deployed node starts burrowing its head 304 as indicated in FIG. 8. While the ROV 600 deploys the nodes, or after the ROV has finished deploying the nodes, AUV 400 is deployed, from the same vessel 730 or another vessel or platform. AUV 400 approaches deployed nodes 300 and starts to verify their positions, i.e., if they are on the predetermined grid. AUV 400 may also check the status of each node and the status of their heads.

Once AUV 400 determines that the nodes are in place, operational and their heads have been buried to the desired depth, the nodes are ready to acquire and record seismic data. By having the seismic sensor embedded in the seabed, the coupling of the two is greatly improved, thus, acquiring high-quality seismic data. In one application, different depths are used for the plural nodes, i.e., one row of nodes may burrow their heads to a first depth, a second row of nodes may burrow their heads to a second depth, and so on. In one application, a source vessel 810 tows a seismic source 812 and shoots this source for producing seismic waves. In another application, source vessel 810 may be the same as vessel 730. In still another application, one or more nodes 300 have their own seismic source and they use these local seismic sources to generate seismic waves. In still another application, cage 700 is equipped with a seismic source 740 and this source is used for generating seismic waves.

During the seismic survey, nodes 300 may acquire not only seismic data but also non-seismic data, e.g., system position, environmental data (i.e., currents, temperature, salinity, speed of p-waves, speed of s-waves, etc.), geo-mechanical data, etc. The data may be recorded continuously or at predetermined times. In one application, the AUV may detect and record the non-seismic data noted above. After enough data is transferred from the nodes to the AUV, the AUV may surface and dock with its support vessel to transfer the data to the vessel. In an alternative embodiment, the AUV may approach cage 700 and transfer its data to a storage device 750 attached to the cage. The transfer may be wireless or wired through an appropriate interface 752. The seismic data may then be transferred from cage 700 to its support vessel 730 through connecting device 732. Thus, connecting device 732 may provide not only a strength member, but also a conduit for data transfer and a conduit for power transfer.

AUV 400 is also in charge of monitoring nodes' performance. Thus, AUV 400 hovers above the nodes to make contactless connections with them and monitors whether the nodes are active and recording data, checks components' status, power units status, data storage capacity, etc. In one application, AUV 400 may make direct contact with the nodes. During this phase, AUV 400 may determine that one or more nodes have a depleted power supply unit. In this case, a few scenarios are possible. According to a first scenario, the AUV itself may contact the node and transfer electric power to recharge the node's power supply. According to a second scenario, AUV 400 instructs ROV 600 or the operator of ROV 600 to recharge the power supply of a given node. For this situation, ROV 600 moves above the given node 300 and recharges its power supply unit. According to another scenario, ROV 600 may move next to the node and replace its depleted power unit with a charged power unit. ROV 600 may fetch the charged power unit from cage 700 or directly from its support vessel.

In another embodiment, AUV 400 may determine that a node is not working. Thus, AUV 400 informs ROV 600 or its operator about this situation and a decision may be made to replace the entire node. ROV 600 approaches the faulty node while carrying a new node and performs the swap. The new node may be fetched from cage 700 or from the ROV's support vessel. The new node may be activated by AUV 400, i.e., burrow its head and start recording seismic data.

When the seismic survey is concluded, the nodes are deactivated and prepared for retrieval. A signal indicative of the survey's end is either generated by the nodes' internal electronics, or sent by the AUV, ROV or one of the vessels. Upon receiving this signal, each node stops recording seismic data, pulls its head from the seabed (if the head is stuck, the node is configured to release the support member 306 and leave the head behind), and powers down its components. ROV 600 starts picking up the nodes and returning them to their slots in cage 700. Once cage 700 is full, vessel 730 retrieves the cage and empties the nodes. Another cage or the same cage is sent again to continue the retrieval operation. Maintenance operations are then performed on each component of the system to prepare it for a new mission. The processes discussed above may be performed with AUVs instead of nodes 300. For this scenario, each AUV may have its own head that houses the seismic sensor and the head burrows into the seabed after the AUVs land on the seafloor. The deployment and retrieval of AUVs may be similar to those of the nodes or achieved without the help of the cage, ROV, etc., by directly sending the AUVs from the vessels to the seabed and back.

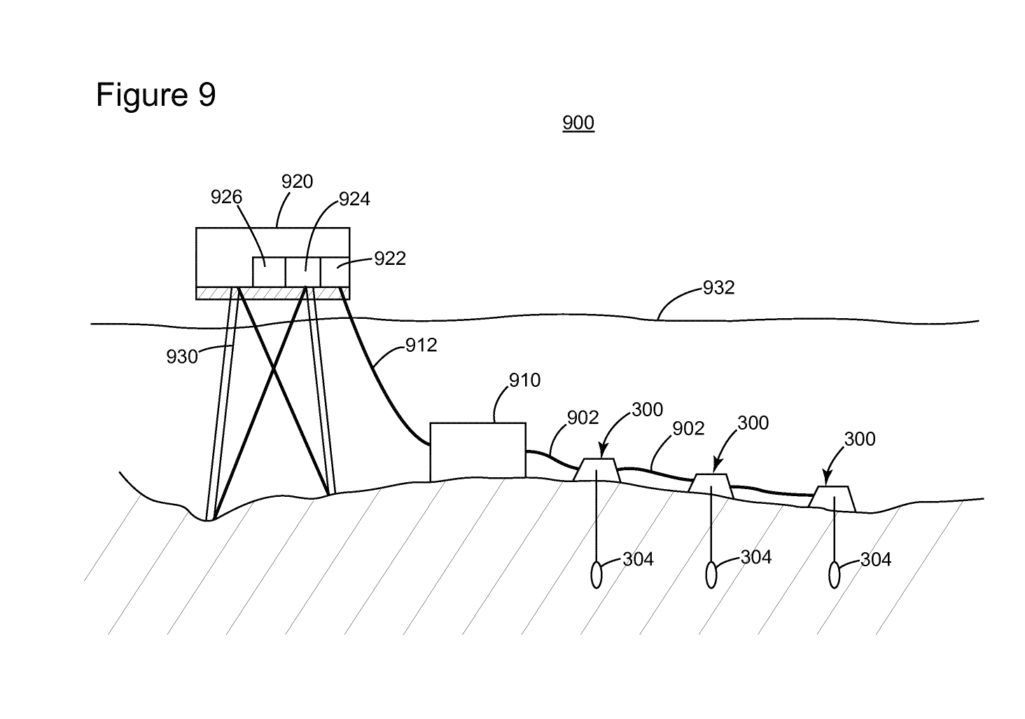

According to another embodiment illustrated in FIG. 9, a system 900 includes the same nodes 300 having burrowing heads 304. However, this time, nodes 300 are connected to each other by cables 902 connected to a subsea power and data terminal 910. Subsea power and data terminal 910 is connected in turn to a power and data source 920 through a cable 912. Cables 902 and 912 may transfer not only power but also data, i.e., they may include dedicated wires for electric power and dedicated wires (e.g., optical cable) for data communications. Power and data source 920 may include a high-voltage power generator 922, which may generate alternate current. Power and data source 920 may be installed on a rig 930, that is stationary above the seabed and/or water surface 932. It may also include a large storage device 924 for storing seismic and non-seismic data transmitted by nodes 300. Various processing means (e.g., processor) 926 may also be present on rig 930 for analyzing the recorded seismic data.

Subsea power and data terminal 910 may include one or more DC/AC inverters or AC/DC converters, depending on how it is wired. For example, power and data source 920 may transmit DC power or AC power. Depending upon which approach is taken, subsea power and data terminal 910 transform this power into DC power, which is then further transmitted to nodes 300. Thus, subsea power and data terminal 910 may include wet-mate connectors both for voltage and data and may supply a large amount of power, e.g., about 10 kW. In another embodiment, multiple subsea power and data terminals 910 may be used to connect to the plural nodes 300. In still another embodiment, the subsea power and data terminal 910 may be part of the cage 700 illustrated in FIGS. 7 and 8. The operational aspects discussed with regard to FIG. 8 equally apply to this embodiment and, thus, they are not repeated herein.

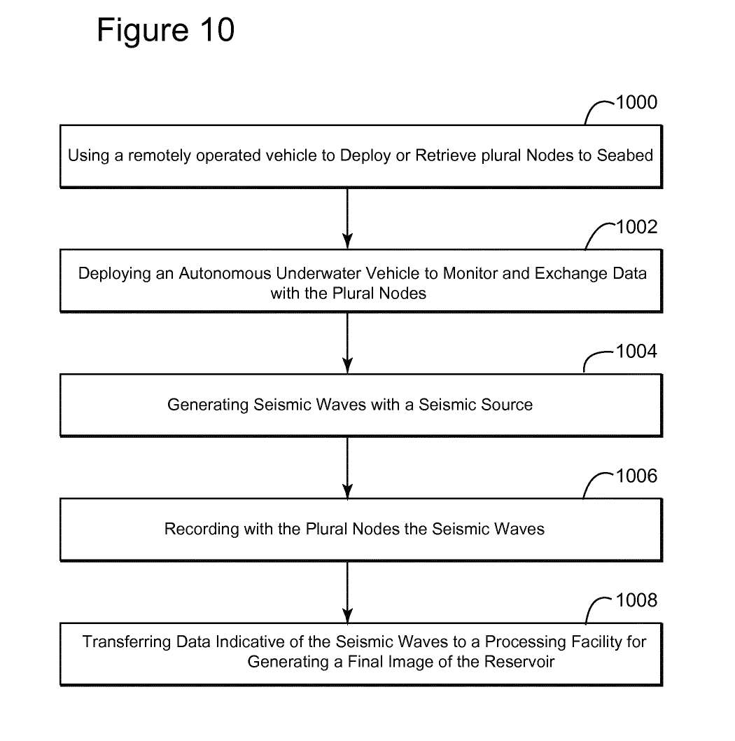

According to an embodiment illustrated in FIG. 10, there is a method for monitoring a reservoir underwater. The method includes a step 1000 of using a remotely operated vehicle to deploy or retrieve plural nodes to the seabed; a step 1002 of deploying an autonomous underwater vehicle to monitor and exchange data with the plural nodes; a step of generating seismic waves with a seismic source; a step 1004 of recording with the plural nodes the seismic waves; and a step 1006 of transferring data indicative of the seismic waves to a processing facility for generating a final image of the reservoir. At least one node of the plural nodes has a head that houses the seismic sensor and is configured to bury itself in the seabed, up to a predetermined depth, and the head remains in electrical contact through a connector with a base of at least one node during the seismic survey.

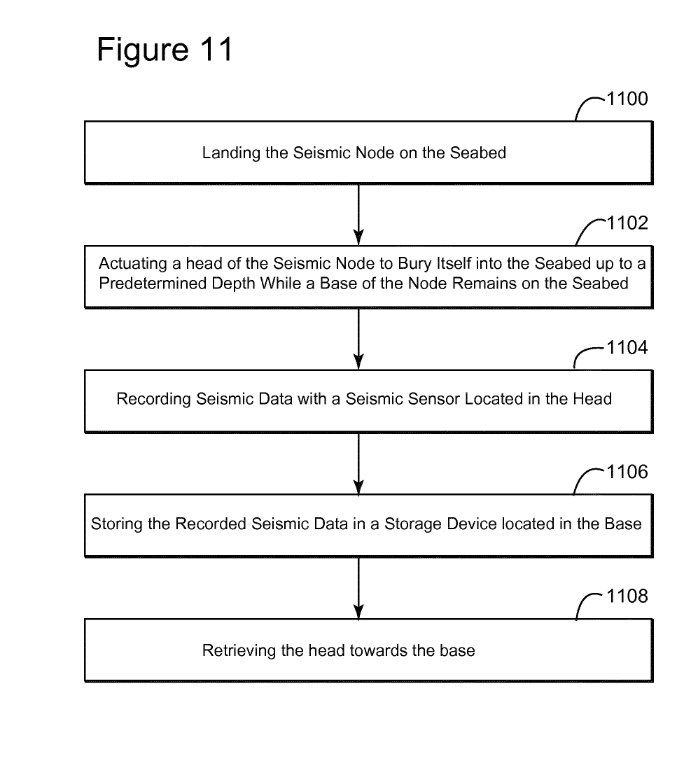

According to another embodiment illustrated in FIG. 11, there is a method for deploying a seismic node on the seabed. The method includes a step 1100 of landing the seismic node on the seabed, a step 1102 of actuating a head of the seismic node to bury itself into the seabed up to a predetermined depth while the base of the node remains on the seabed, a step 1104 of recording seismic data with a seismic sensor located in the head, a step 1106 of storing the recorded seismic data in a storage device located in the base, and a step 1108 of retrieving the head toward the base.

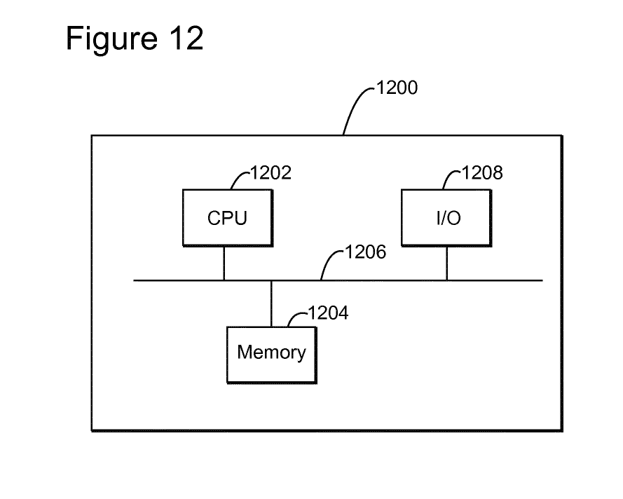

With regard to the various controllers discussed above, a possible configuration of such a device is schematically illustrated in FIG. 12. Such a controller 1200 includes a processor 1202 and a storage device 1204 that communicate with each other via a bus 1206. An input/output interface 1208 also communicates with the bus 1206 and allows an operator to communicate with the processor or the memory, for example, to input software instructions for operating the nodes, ROV, AUV, etc. The input/output interface 1208 may also be used by the controller to communicate with other controllers or interfaces that are provided on the various components of the system. For example, the input/output interface 1208 may communicate with a GPS system (not shown) for acquiring the actual position of the AUV at launch time, or with an acoustical system. The controller 1200 may be a computer, a server, a processor or dedicated circuitry.

One or more of the exemplary embodiments discussed above disclose a system and method for seismic monitoring, undersea, a reservoir. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A system for monitoring a reservoir underwater, the system comprising:
plural nodes, each having a seismic sensor for detecting seismic waves;
a remote operated vehicle (ROV) configured to deploy or retrieve the plural nodes to seabed; and
an autonomous underwater vehicle (AUV) configured to monitor and exchange data with the plural nodes,
wherein at least one node of the plural nodes has a head that houses the seismic sensor and the head is configured to burrow in the seabed, up to a predetermined depth, and
the head remains in electrical contact through a connector with a base of the at least one node and the head houses the seismic sensor.

2. The system of claim 1, wherein the base of the at least one node further comprises:
a power supply unit;
a seismic data acquisition unit electrically connected to the seismic sensor;
a controller configured to coordinate the burial of the head;
a power supply interface configured to receive power from the ROV or AUV; and
a data and control interface configured to exchange data with the ROV or AUV.

3. The system of claim 2, wherein the head further comprises:
a reel for wounding connector; and
an actuator configured to advance a motion of the head into the seabed.

4. The system of claim 3, further comprising:
a seismic source configured to generate seismic waves.

5. The system of claim 1, further comprising:
a cage configured to store part of the plural nodes, wherein the cage is configured to be deployed from a vessel on the seabed.

6. The system of claim 5, wherein the ROV has a robotic arm with which fetches the at least one node from the cage and deploys it on the seabed.

7. The system of claim 6, wherein the ROV is programmed to deploy the plural nodes on a grid.

8. The system of claim 5, wherein the AUV detects that a node has a depleted power supply unit.

9. The system of claim 8, wherein the ROV has a robotic arm with which fetches a charged power supply unit from the cage and replaces the depleted power supply unit of the node with the charged power supply.

10. The system of claim 1, wherein the AUV detects a status of the plural nodes.

11. The system of claim 10, wherein the status includes at least one of a power status, head status, seismic recording status, and location information of the node.

12. The system of claim 1, further comprising:
a support vessel that stores the cage when not deployed and provides control to the ROV.

13. The system of claim 12, further comprising:
a source vessel that tows a seismic source that is configured to generate seismic waves.

14. A method for monitoring a reservoir underwater, the method comprising:
using a remote operated vehicle (ROV) to deploy or retrieve plural nodes to seabed;
deploying an autonomous underwater vehicle (AUV) to monitor and exchange data with the plural nodes;
generating seismic waves with a seismic source;
recording with the plural nodes the seismic waves; and
transferring data indicative of the seismic waves to a processing facility for generating a final image of the reservoir,
wherein at least one node of the plural nodes has a head that houses the seismic sensor and the head is configured to burrow in the seabed, up to a predetermined depth, and
the head remains in electrical contact through a connector with a base of the at least one node during the seismic survey.

15. The method of claim 14, further comprising:
sending the AUV to each node to collect the seismic data; and
transferring the seismic data from the AUV to surface.

16. The method of claim 14, further comprising:
deploying a cage on the seabed, the cage being configured to store nodes and replacing power units for the nodes.

17. The method of claim 16, further comprising:
sending the AUV to each node to collect status information;
informing the ROV when a power unit of a node is found to be depleted; and
replacing the depleted power unit of the node with a charged power unit from the cage.

18. The method of claim 17, further comprising:
replacing, using the ROV, a faulty node with a new node from the cage when the AUV detects the faulty node.

19. A system for monitoring a reservoir underwater, the system comprising:
plural nodes, each having a seismic sensor for detecting seismic waves;
a remote operated vehicle (ROV) configured to deploy or retrieve the plural nodes to seabed;
an autonomous underwater vehicle (AUV) configured to monitor and exchange data with the plural nodes;
a vessel configured to provide support for the AUV and the ROV; and
a cage that is deployed from the vessel to the seabed and configured to store part of the plural nodes,
wherein at least one node of the plural nodes has a head that houses the seismic sensor and the head is configured to burrow in the seabed, up to a predetermined depth.

20. The system of claim 19, wherein the base of the at least one node further comprises:
a power supply unit,
a seismic data acquisition unit electrically connected to the seismic sensor,
a controller configured to coordinate the burial of the head,
a power supply interface configured to receive power from the ROV or AUV, and
a data and control interface configured to exchange data with the ROV or AUV; and
wherein the head further comprises:
a reel for wounding connector,
an actuator configured to advance a motion of the head into the seabed, and
a seismic source configured to generate seismic waves.
